(19) United States
(12) Patent Application Publication
(10) Pub. No.: US 2025/0077913 A1
(43) Pub. Date: Mar. 6, 2025

(54) USER INTERFACE FOR IMPROVED LARGE LANGUAGE MODEL INTEGRATION

(71) Applicant: Navan, Inc., Palo Alto, CA (US)

(72) Inventors: Andrei Vodeniktov, Sunnyvale, CA (US); Ishay Shushu Inbar, Neot HaKikar (IL)

(21) Appl. No.: 18/826,583

(22) Filed: Sep. 6, 2024

Related U.S. Application Data
(60) Provisional application No. 63/580,964, filed on Sep. 6, 2023.

(51) Int. Cl. G06N 5/04

(52) U.S. Cl. CPC G06N 5/04

(57) ABSTRACT

An online system improves the development and deployment of LLM-based applications providing offering an application workflow user interface to developers of these applications. The application workflow UI is a user interface that includes different sections for the efficient design of a workflow and logic for an application operating on the online system. The application workflow UI allows the user to generate UI elements for stages within the overall application workflow and connect those stages through a simple to use interface. The application workflow UI improves the development process of LLM-based applications by allowing the user to set parameters for stages that involve prompting an LLM through the same interface. Specifically, the application workflow UI includes a parameters section that allows the user to specify parameters for prompting the LLM.

### BACKGROUND

This application claims the benefit of U.S. Provisional Application No. 63/580,964, entitled “User Interface for Improved Large Language Model Integration” and filed Sep. 6, 2023, which is incorporated by reference.

### BACKGROUND

Large Language Models (LLMs), such as OpenAI's GPT4, allow users to receive intelligent responses to their prompts. By providing human-like responses to user prompts, companies can leverage LLMs to provide more effective content and services to their users. However, integrating LLMs into a broader system can be technically complicated because the systems must provide prompts to the LLMs and handle the responses. The LLM responses must then be used by the system to select content to present to users or to determine what next action should be taken by the system. Generating LLM prompts and processing LLM responses can be more work than an organization is able or willing to perform to integrate LLMs into their systems, which means that these organizations are not leveraging this new technology.

### SUMMARY

An online system improves the development and deployment of LLM-based applications by offering an application workflow user interface (“UI”) to developers of these applications. The application workflow UI is a user interface that includes different sections for the efficient design of a workflow and logic for an application operating on the online system. The application workflow UI allows the user to generate UI elements for stages within the overall application workflow and connect those stages through a simple to use interface.

The application workflow UI improves the development process of LLM-based applications, such as chatbot applications, by allowing the user to set parameters for stages that involve prompting an LLM through the same interface. Specifically, the application workflow UI includes a parameters section that allows the user to specify parameters for prompting the LLM. For example, the user can specify a prompt or prompt template to use for a stage, may specify which LLM to use for the prompt, or may specify a max size or temperature for the prompt.

The application workflow UI also includes a testing section whereby a user can have the online system translate the application workflow into computer-executable instructions and test the application. The user can provide inputs to the application through the testing section and the online system will display outputs based on the user's inputs in the testing section. The online system may continually identify which stage of the application workflow is being executed while the user is using the testing section and indicate to the user which stage is being currently executed by highlighting the corresponding UI element in the workflow section.

By concurrently presenting these sections in a single user interface, the online system provides a simplified mechanism by which developers can create a workflow for an LLM-based application and deploy the application.

### BRIEF DESCRIPTION OF THE DRAWINGS

FIG. (FIG. 1 illustrates an example system environment for an online system, in accordance with some embodiments.

FIG. 2 illustrates an example application workflow UI, in accordance with some embodiments.

FIG. 3 illustrates an example application workflow UI where a prompt stage element is selected, in accordance with some embodiments.

FIG. 4 illustrates an example application workflow UI for specifying output instructions for a selected prompt stage element, in accordance with some embodiments.

FIG. 5 illustrates an example application workflow UI where an API stage element is selected, in accordance with some embodiments.

FIG. 6 illustrates an example application workflow UI displaying a user testing an application workflow through the testing section, in accordance with some embodiments.

FIG. 7 illustrates an example application workflow UI where another stage element is highlighted as the user progresses through the application workflow, in accordance with some embodiments.

FIG. 8 illustrates an example application workflow UI where the parameters section displays UI elements 800 for selecting parameters for a prompt for a selected prompt stage element 810, in accordance with some embodiments.

FIG. 9 illustrates an example application workflow UI where the parameters section includes elements for memory management instructions that a user can provide for the workflow, in accordance with some embodiments.

FIG. 10 illustrates an example application workflow user interface whereby application workflows can be developed as sub-workflows within a broader application workflow, in accordance with some embodiments.

### DETAILED DESCRIPTION

### System Environment

FIG. (FIG. 1 illustrates an example system environment for an online system 130, in accordance with some embodiments. The system environment illustrated in FIG. 1 includes a user device 100, an entity system 110, a network 120, an online system 130, and a model serving system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

A user can interact with other systems through a user device 100. The user device 100 can be a personal or mobile computing device, such as a smartphone, a tablet, a laptop computer, or desktop computer. In some embodiments, the user device 100 executes a client application that uses an application programming interface (API) to communicate with other systems through the network 120.

The entity system 110 is a computing system operated by an entity. The entity may be a business, organization, or government, and the user may be an agent or employee of the entity.

The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical media for communicating data from one computing device to another computing device, such as MPLS lines, fiber optic cables, cellular connections (e.g., 3G, 4G, or 5G spectra), or satellites. The network 120 also may use networking protocols, such as TCP/IP, HTTP, SSH, SMS, or FTP, to transmit data between computing devices. In some embodiments, the network 120 may include Bluetooth or near-field communication (NFC) technologies or protocols for local communications between computing devices. Similarly, the network 120 may use phone lines for communications. The network 120 may transmit encrypted or unencrypted data.

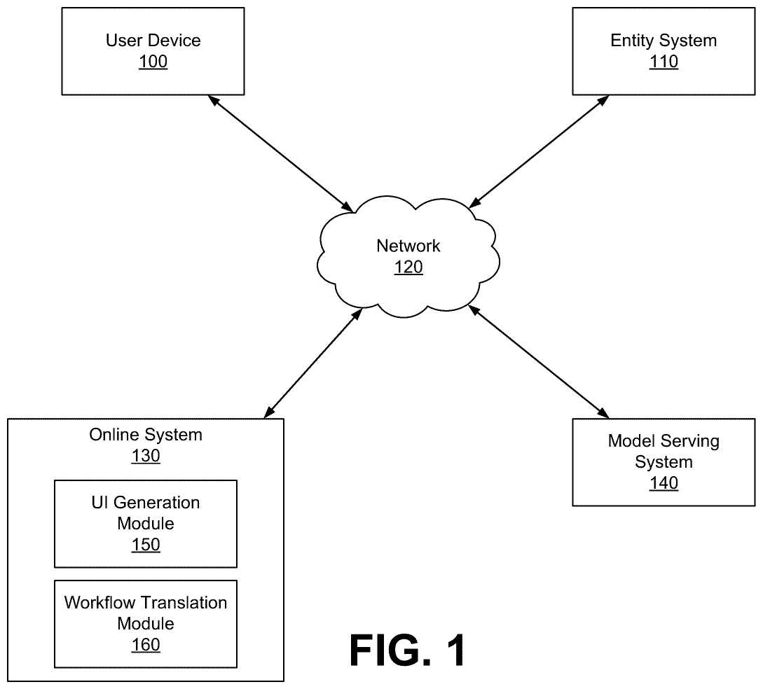

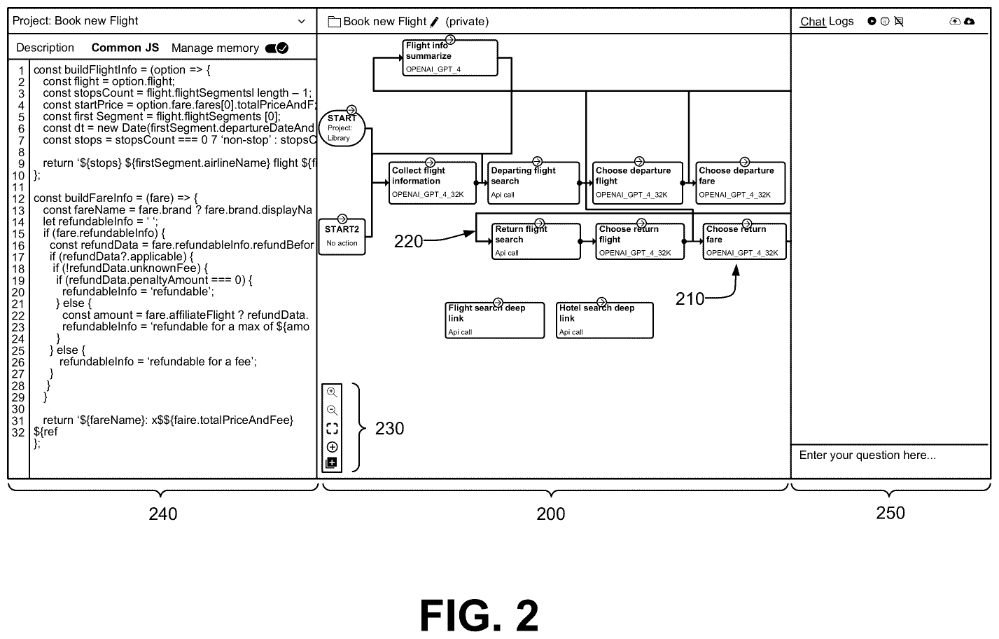

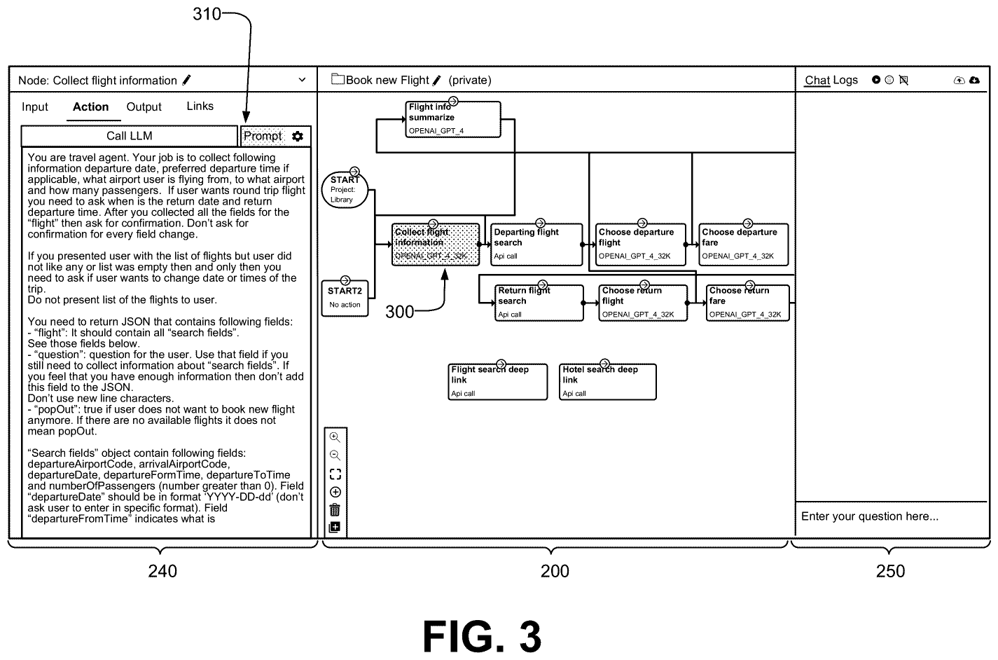

The online system 130 stores information for entities in databases. The online system 130 may have a database for each entity and may store transaction information for the entity in their corresponding database. The online system 130 also may provide a support chat interface through which a user corresponding to an entity can request information on the entity's data stored by the online system 130. For example, the user device 100 may present a chat interface from the online system 130 to the user and the user may use the chat interface to request information from the online system 130. The online system 130 automatically provides answers to the user's request. Example methods for answering a user's request for information are described in further detail below with regards to FIGS. 2 and 3.

The model serving system 140 receives requests from other systems to perform tasks using machine-learned models. The tasks include, but are not limited to, natural language processing (NLP) tasks, audio processing tasks, image processing tasks, video processing tasks, and the like. In one embodiment, the machine-learned models deployed by the model serving system 140 are models configured to perform one or more NLP tasks. The NLP tasks include, but are not limited to, text generation, query processing, machine translation, chatbots, and the like. In one embodiment, the language model is configured as a transformer neural network architecture. Specifically, the transformer model is coupled to receive sequential data tokenized into a sequence of input tokens and generates a sequence of output tokens depending on the task to be performed.

The model serving system 140 receives a request including input data (e.g., text data, audio data, image data, or video data) and encodes the input data into a set of input tokens. The model serving system 140 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens may be arranged as a tensor with one or more dimensions, for example, one dimension, two dimensions, or three dimensions. In an example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 130 or one or more entities different from the online system 130. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

While the model serving system 140 is depicted as separate from the online system 130 in FIG. 1, in alternative embodiments, the model serving system 140 is a component of the online system 130.

Though the system can be applied in many environments, in one example, the online system 130 is an expense management system. An expense management system is a computing system that manages expenses incurred for an entity by users. An example system is described in further detail in U.S. patent application Ser. No. 18/487,821 filed Oct. 16, 2023, which is incorporated by reference.

In FIG. 1, the online system 130 includes a UI generation module 150 and a workflow translation module 160. Alternative embodiments may include more, fewer, or different components from those illustrated in FIG. 1, and the functionality of each component may be divided between the components differently from the description below. Additionally, while the description below primarily describes the functionality of the modules as being performed by the online system, some or all of the functionality of the UI generation module 150 and the workflow translation module 160 may be performed by other systems, such as the user device 100, the entity system 110, or the model serving system 140. For example, user interface elements may be generated by the user device 100 or the user device may translate a user interface into executable code for an application workflow.

The UI generation module 150 generates user interfaces for presentation through a client application on a user device 100. For example, the UI generation module 150 generates user interfaces for developing a workflow for an LLM-based application. A workflow includes stages that represent steps in the overall execution of the application. For example, each stage may be associated with a set of computer-executable instructions to be executed by the online system as part of the LLM-based application.

Each stage in the workflow may have an associated stage type. For example, some stages may be prompt stages, which are a type of stage that involves a prompt to a large language model (LLM). These prompt stages may be associated with free text for a prompt or a prompt template to transmit to an LLM and parameters for the prompt. In some embodiments, prompt stages may include an identifier for which LLM should be used for the prompt. In some embodiments, the stages may be database query stages, which are a type of stages that involve a query (e.g., a SQL query) to a database to collect data requested in the query. The database may be one stored by the online system or stored by some third-party system (e.g., the entity system or the model serving system). Similarly, some stages may be API stages, which are a type of stages that involves using an application programming interface (API) to interact with another system, such as another subsystem within the online system or a third-party system. Furthermore, some stages may involve executing some other process or system within the online system to perform some functionality as part of the stage (e.g., applying a stored machine-learning model to certain data or performing certain confidentiality or privacy checks on data).

Stages may also include input instructions or output instructions, which are computer-executable instructions that pre-process or post-process, respectively, data for the stage. For example, the input instructions may extract data from a data structure (e.g., a JSON file) received from another stage for use by a main-action part of the stage. Similarly, the output instructions may use data generated by the main-action part of the stage to generate a data structure (e.g., a JSON file) for transmission to another stage. The output instructions may also include instructions on which stage the output of the stage should be transmitted to.

The UI generation module generates a workflow for an LLM-based application by generating a UI element for each stage in the workflow. Each stage element stores the instructions for the main action performed during the corresponding stage of the workflow and displays the instructions when the user views the stage element. For example, a stage element for a prompt stage may include the prompt or prompt template for a prompt to be sent to an LLM. Each stage element may also store the input or output instructions for the stage.

The UI generation module also generates UI elements that represent connections between stages. For example, the connection elements may indicate where the output of one stage is the input of another stage.

The workflow translation module 160 translates a workflow user interface into computer-executable instructions for execution by the online system. For example, if a stage element includes source code as part of its instructions (e.g., main-action, input instructions, or output instructions), the workflow translation module 160 may compile the source code into executable code. Similarly, the workflow translation module 160 may generate instructions that link stages in the workflow together based on stage elements that are connected using connection elements.

To translate a workflow user interface into instructions for execution by the online system, the workflow translation module 160 receives a workflow user interface that includes a set of stage elements. As noted above, the stage elements may have different types, such as prompt element, query elements, or API elements. The stage elements are connected to each other through connection elements, which represent where an output of one stage should be used as an input to another stage. The workflow translation module 160 may receive the workflow user interface from the UI generation module 150 or the user device 100.

The workflow translation module translates each stage element and each connection element into computer-executable instructions for executing the application workflow on the online system. For example, the workflow translation module may generate instructions to execute processes on certain subsystems within the online system to perform some or all of the functionalities of a stage. Similarly, the workflow translation module may generate instructions to query a third-party system for information.

The online system executes the instructions generated by the workflow translation module as part of an LLM-based application operating on the online system. This application may be accessed by users through client applications or web browsers operating on client devices (e.g., user device 100).

### Example Method for Generating Database Queries

FIGS. 2-10 depict example user interfaces for generated an LLM-based application workflow, in accordance with some embodiments. The user interfaces depicted in FIGS. 2-10 represent a workflow for a chatbot application. In particular, the chatbot application allows a user to book a flight through the chatbot application. However, this embodiment is merely an example for how the example user interface may be used to generate an LLM-based application and is not limited to the particular chatbot application illustrated in the figures, nor to chatbot applications generally.

FIG. 2 illustrates an example application workflow UI, in accordance with some

embodiments. The UI includes a workflow section 200 that depicts a set of stage elements 210 and connections elements 220 that connect the stage elements 210. The workflow section includes options 230 to change the workflow (e.g., to add, edit, or remove elements from the workflow).

The application workflow UI also includes a parameters section 240, which is a section of the UI that allows a user to set parameters for the workflow. For example, FIG. 2 illustrates an example display of the parameters section 240 where no elements in the workflow are currently selected and the user can thereby set parameters (e.g., instructions for global variables or functions) for the workflow as a whole.

The application workflow UI further includes a testing section 250. The testing section 250 enables a user of the user interface to test the current version of the application workflow. The testing section 250 may include options to cause the online system to generate executable instructions for executing the application based on the current version of the workflow as embodied in the workflow section 200. The testing section is described in further detail below.

FIG. 3 illustrates an example application workflow UI where a prompt stage element 300 is selected, in accordance with some embodiments. The parameters section 240 includes a UI element 310 whereby the user can input the text for a prompt or prompt template to be transmitted to an LLM. A prompt template that is input to the parameters section 240 may refer to fields of an input data structure (e.g., a JSON file) to generate a prompt to transmit to the LLM.

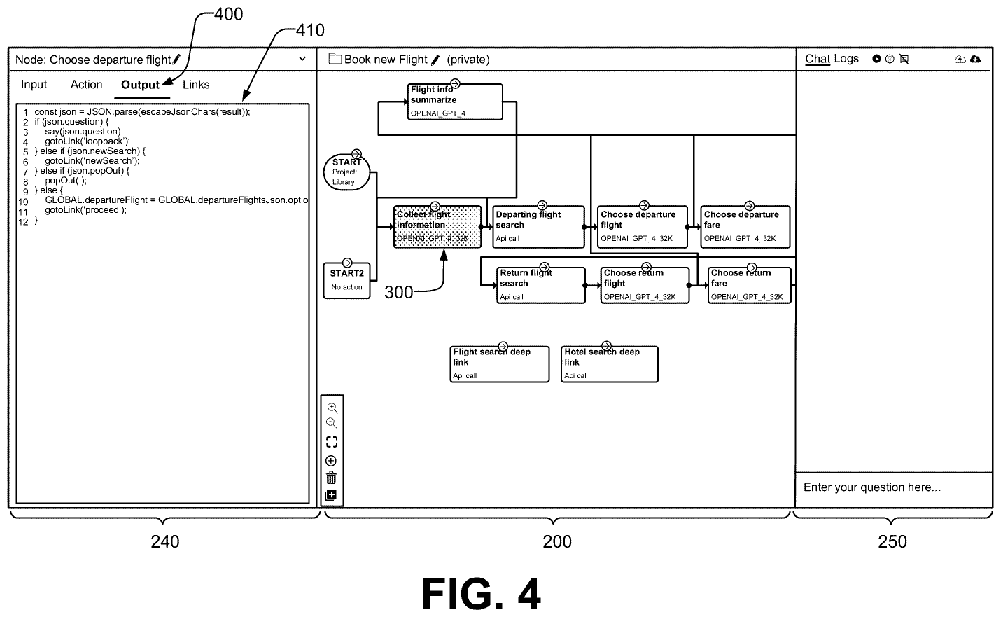

FIG. 4 illustrates an example application workflow UI for specifying output instructions for a selected prompt stage element 300, in accordance with some embodiments. Specifically, the parameters section 240 includes a tab 400 for presenting an element 410 for inputting the output instructions. A similar UI may be used for other types of stage elements or for providing input instructions for a stage element.

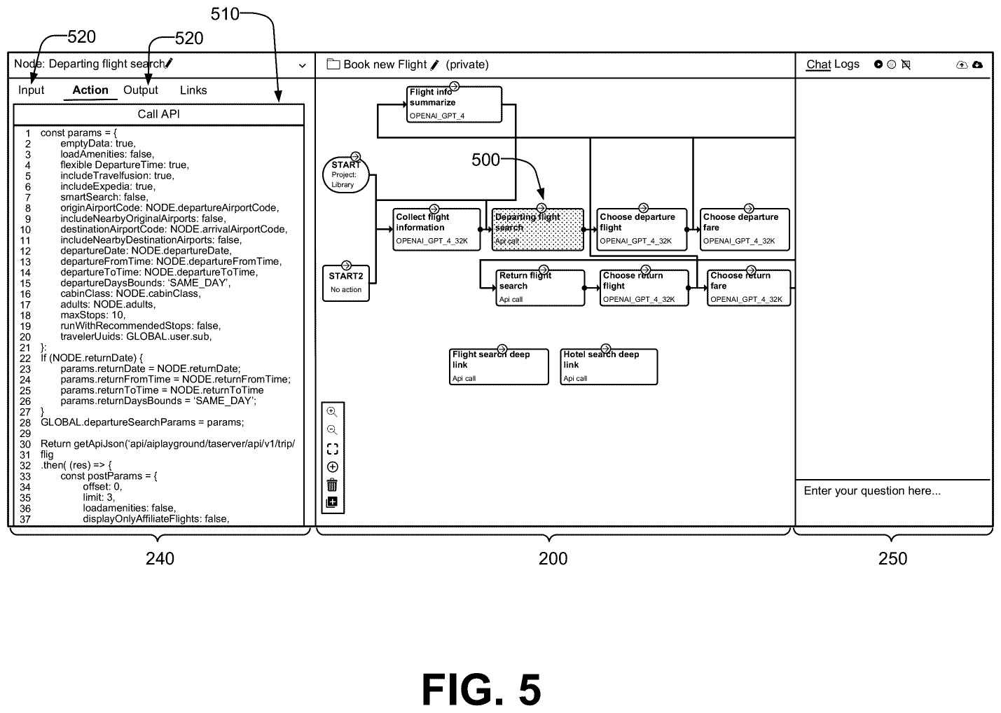

FIG. 5 illustrates an example application workflow UI where an API stage element 500 is selected, in accordance with some embodiments. The parameters section 240 presents an interface 510 by which the user can input instructions for requesting information from another system. Like for prompt stage elements, the parameters section 240 includes elements 520 that the user can select to provide input instructions or output instructions for the API stage.

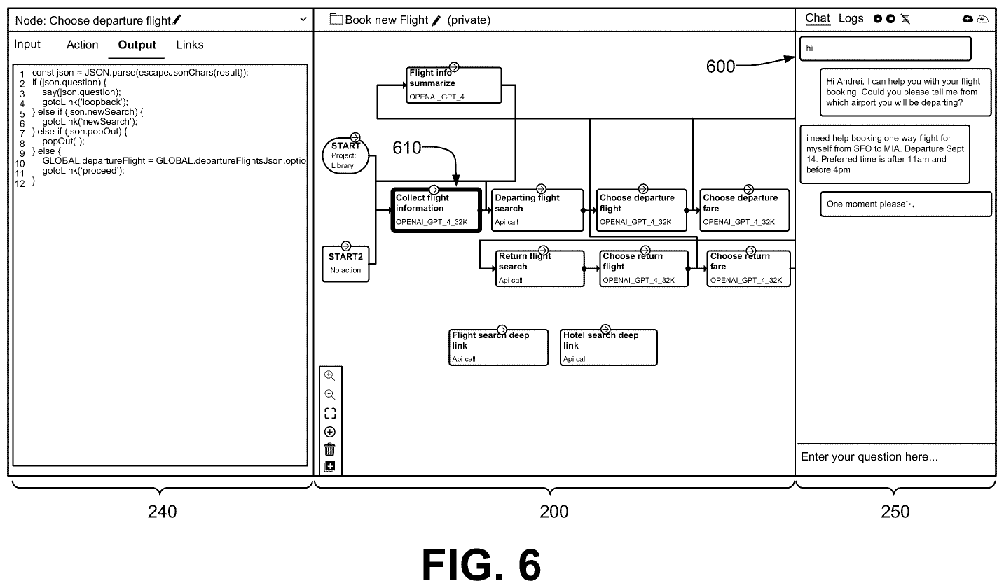

FIG. 6 illustrates an example application workflow UI displaying a user testing an application workflow through the testing section 250, in accordance with some embodiments. In the illustrated embodiment, the user interacts 600 with the chatbot application by inputting questions or information to the testing section 250. As the chatbot application progresses through the application workflow, the workflow section 200 highlights 610 the current stage of the progression.

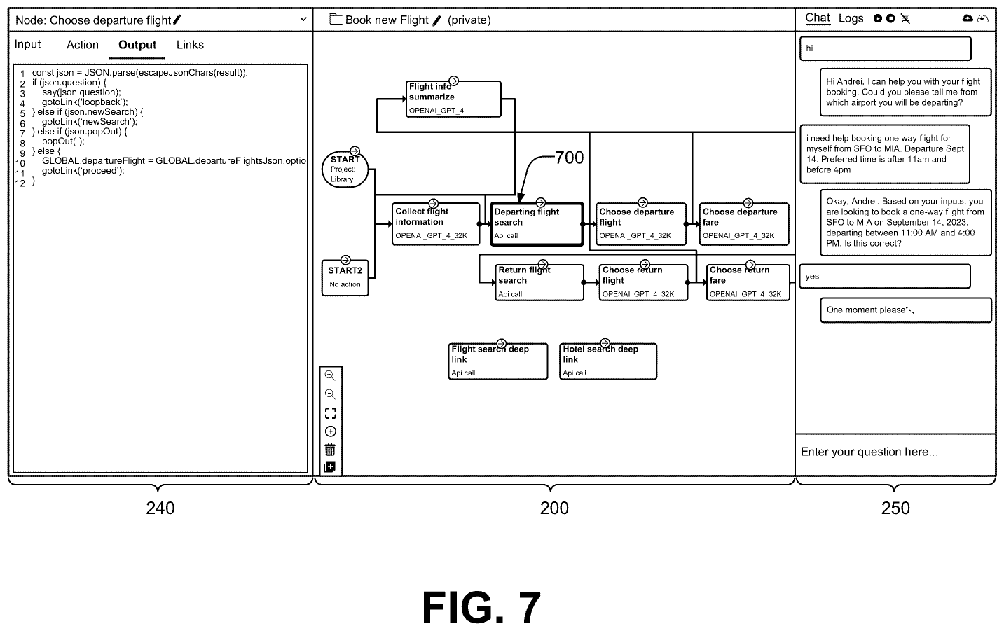

FIG. 7 illustrates an example application workflow UI where another stage element 700 is highlighted as the user progresses through the application workflow, in accordance with some embodiments.

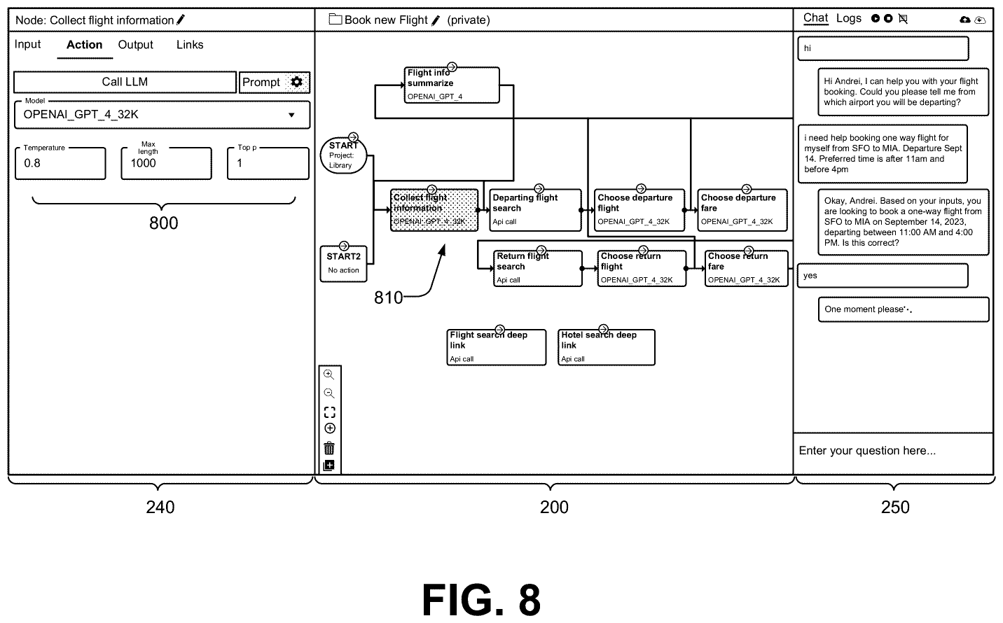

FIG. 8 illustrates an example application workflow UI where the parameters section 240 displays UI elements 800 for selecting parameters for a prompt for a selected prompt stage element 810, in accordance with some embodiments. For example, the user may select which LLM to use for the prompt stage or the temperature of the LLM's response.

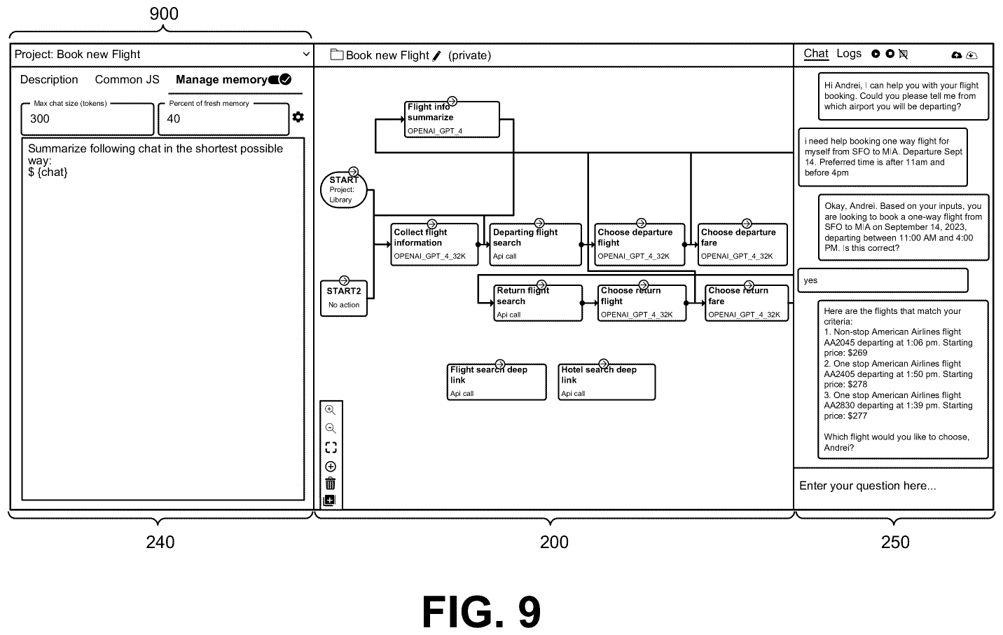

FIG. 9 illustrates an example application workflow UI where the parameters section includes elements 900 for memory management instructions that a user can provide for the workflow, in accordance with some embodiments. For example, the user can limit a number of tokens that can be provided in LLM prompts or ask the LLM to summarize the chat between the online system and the user to reduce the amount of text that is used for prompts.

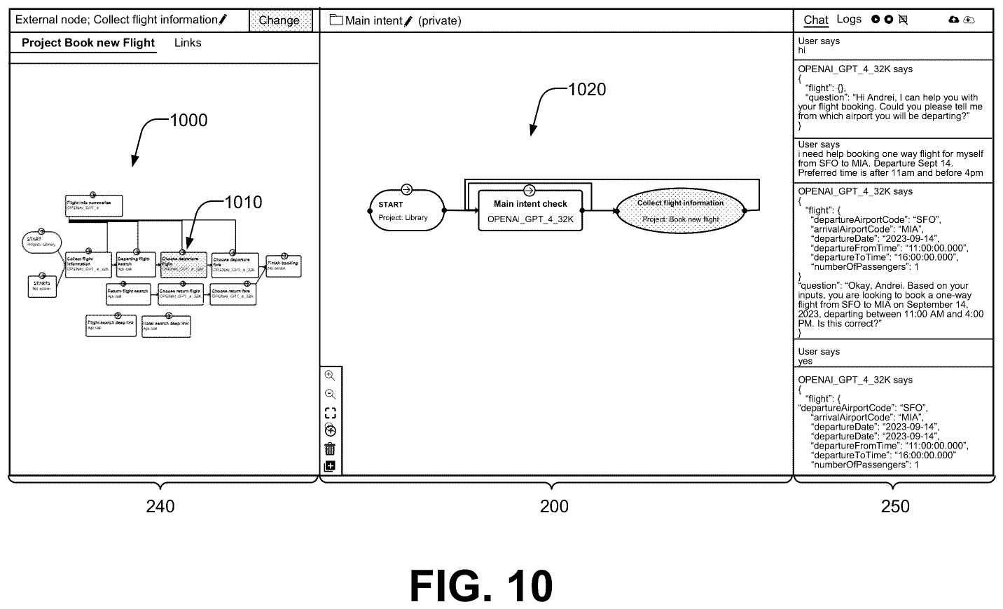

FIG. 10 illustrates an example application workflow user interface whereby application workflows can be developed as sub-workflows within a broader application workflow, in accordance with some embodiments. The user interface depicts the broader workflow 1000 in the parameter section 240 and indicates the stage element 1010 that corresponds to a sub-workflow. The application workflow user interface depicts the sub-workflow 1020 in the workflow section 200.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A non-transitory computer-readable medium storing instructions that, when executed by a computer system, cause the computer system to perform operations comprising:
receiving a plurality of prompt stages through an application workflow user interface presented on a client device, wherein each prompt stage is a stage in a workflow for an application executing on an online system and wherein each prompt stage represents a prompt to be transmitted to a large language model;
presenting a prompt stage element for each of the plurality of prompt stages in a workflow section of the application workflow user interface, wherein each prompt stage element is a user interface element representing the corresponding prompt stage element in the workflow section of the application workflow user interface;
receiving prompt text for each prompt stage element through a parameters section of the application workflow user interface, wherein the prompt text for a prompt stage element comprises text for the prompt for the corresponding prompt stage;
translating the plurality of prompt stage elements into computer-executable instructions to execute the workflow of the application on the online system; and
executing the computer-executable instructions on the online system.

2. The non-transitory computer-readable medium of claim 1, wherein the application is a chatbot application.

3. The non-transitory computer-readable medium of claim 1, wherein the operations further comprise:
receiving a plurality of query stages through the application workflow user interface, wherein each query stage is a stage in the workflow for the application and wherein each query stage represents a query to a database to collect information stored in the database; and
presenting a query stage element for each of the plurality of query stages in the workflow section of the application workflow user interface.

4. The non-transitory computer-readable medium of claim 1, wherein the operations further comprise:
receiving a plurality of query stages through the application workflow user interface, wherein each query stage is a stage in the workflow for the application and wherein each query stage represents a query to a database to collect information stored in the database; and
presenting a query stage element for each of the plurality of query stages in the workflow section of the application workflow user interface.

5. The non-transitory computer-readable medium of claim 1, wherein the operations further comprise:
receiving, through the application workflow user interface, an indication of a connection between a first prompt stage and a second prompt stage of the plurality of prompt stages, wherein the connection indicates that an output of the first prompt stage is an input to the second prompt stage; and
presenting a connection element corresponding to the connection in the workflow section of the application workflow user interface, wherein the connection element is a user interface element representing the connection between the first prompt stage and the second prompt stage.

6. The non-transitory computer-readable medium of claim 1, wherein the large language model is a machine-learning model executed on the online system or on a third-party system.

7. The non-transitory computer-readable medium of claim 1, the operations further comprising:
receiving input instructions and output instructions for each prompt stage element of the plurality of prompt stage elements through the parameters section of the application workflow user interface.

8. The non-transitory computer-readable medium of claim 7, wherein the output instructions for a prompt stage element comprise computer-readable instructions for generating a data structure storing information from a response from the large language model, wherein the data structure is generated for use in a subsequent stage in the workflow.

9. The non-transitory computer-readable medium of claim 8, wherein the data structure is a JSON file.

10. The non-transitory computer-readable medium of claim 7, wherein the input instructions for a prompt stage element comprise computer-readable instructions for extracting information from a data structure for inclusion in a prompt corresponding to the prompt stage element.

11. The non-transitory computer-readable medium of claim 1, wherein the operations further comprise:
receiving, through the parameters section, a selection of which large language model to use for each prompt stage of the plurality of prompt stages.

12. The non-transitory computer-readable medium of claim 1, wherein executing the computer-executable instructions on the online system comprises:
receiving an input from the user through a testing section of the application workflow user interface;
executing the computer-executable instructions for the application on the input; and
providing an output of the executed computer-executable instructions to the user through the testing section.

13. The non-transitory computer-readable medium of claim 12, wherein executing the computer-executable instructions comprises:
continually identifying a current stage of the application workflow as the workflow is executed through the computer-executable instructions; and
continually modifying the workflow section to identify the prompt stage element corresponding to the current stage of the workflow.

14. A method comprising:
receiving a plurality of prompt stages through an application workflow user interface presented on a client device, wherein each prompt stage is a stage in a workflow for an application executing on an online system and wherein each prompt stage represents a prompt to be transmitted to a large language model;
presenting a prompt stage element for each of the plurality of prompt stages in a workflow section of the application workflow user interface, wherein each prompt stage element is a user interface element representing the corresponding prompt stage element in the workflow section of the application workflow user interface;
receiving prompt text for each prompt stage element through a parameters section of the application workflow user interface, wherein the prompt text for a prompt stage element comprises text for the prompt for the corresponding prompt stage;
translating the plurality of prompt stage elements into computer-executable instructions to execute the workflow of the application on the online system; and
executing the computer-executable instructions on the online system.

15. The method of claim 14, wherein the application is a chatbot application.

16. The method of claim 14, further comprising:
receiving a plurality of query stages through the application workflow user interface, wherein each query stage is a stage in the workflow for the application and wherein each query stage represents a query to a database to collect information stored in the database; and
presenting a query stage element for each of the plurality of query stages in the workflow section of the application workflow user interface.

17. The method of claim 14, further comprising:
receiving a plurality of query stages through the application workflow user interface, wherein each query stage is a stage in the workflow for the application and wherein each query stage represents a query to a database to collect information stored in the database; and
presenting a query stage element for each of the plurality of query stages in the workflow section of the application workflow user interface.

18. The method of claim 14, further comprising:
receiving, through the application workflow user interface, an indication of a connection between a first prompt stage and a second prompt stage of the plurality of prompt stages, wherein the connection indicates that an output of the first prompt stage is an input to the second prompt stage; and
presenting a connection element corresponding to the connection in the workflow section of the application workflow user interface, wherein the connection element is a user interface element representing the connection between the first prompt stage and the second prompt stage.

19. The method of claim 14, wherein the large language model is a machine-learning model executed on the online system or on a third-party system.

20. The method of claim 14, further comprising:
receiving input instructions and output instructions for each prompt stage element of the plurality of prompt stage elements through the parameters section of the application workflow user interface.
